(19) United States
(12) Patent Application Publication
(10) Pub. No.: US 2013/0044934 A1
(43) Pub. Date: Feb. 21, 2013

(54) APPARATUS AND METHOD OF DETECTING COUNTERFEIT CURRENCY

(71) Applicant: Trent Alan Tolene, Glens Falls, NY (US)

(72) Inventor: Trent Alan Tolene, Glens Falls, NY (US)

(21) Appl. No.: 13/466,168

(22) Filed: May 8, 2012

Related U.S. Application Data
(60) Provisional application No. 61/524,413, filed on Aug. 17, 2011.

(51) Int. Cl. G06K 9/46

(52) U.S. Cl. 382/135

(57) ABSTRACT

An apparatus comprising a detection device for detecting a detectable property of currency, wherein the detection device has a detection surface at least one of embedded into the detection device and within a handheld portion is provided. Furthermore, a method of detecting counterfeit currency is also provided.

### CROSS-REFERENCE TO RELATED APPLICATIONS

This application is a non-provisional application claiming the benefit of and priority to U.S. Provisional Application No. 61/524,413, filed on Aug. 17, 2011, and entitled “Apparatus and Method of Detecting Counterfeit Currency.”

### FIELD OF TECHNOLOGY

The following relates to detecting counterfeit currency and more specifically to embodiments of an apparatus and method for detecting counterfeit currency at a cash register or other point of sale.

### BACKGROUND

Counterfeiting currency is one of the oldest crimes in history, yet counterfeiting continues to be a major problem for law enforcement throughout the world. The technology to facilitate counterfeiting currency is always adapting to evade capture by the government. For instance, counterfeiters have adapted from offset printing, which has its own set of required skills, to computer-generated counterfeiting. Today's counterfeiter is able to produce counterfeit currency with basic computer training and skills afforded by trial and error, and public education. Accordingly, counterfeit passing statistics are likely to increase because counterfeiting instruments are more readily available, the capabilities of these machines continue to improve, and the techniques are more readily understood by an increasingly larger segment of the population, including those with criminal intent. Moreover, producing counterfeit currency causes major problems both on a large scale, such as hurting a nation's economy, and on a small scale, such as a small business owner being cheated.

Thus, a need exists for an apparatus and method for detecting counterfeit currency at a point of sale.

### SUMMARY

A first aspect relates generally to a device for detecting counterfeit currency, the device comprising a first scanning device, the first scanning device configured to emit a signal to detect a detectable property of a valuable object if placed nearby the first scanning device, a first detection surface, the first detection surface located proximate the first scanning device, the first detection surface allowing a passage of the signal emitted by the first scanning device to detect the detectable property of the valuable object if placed nearby the first scanning device, a second scanning device, the second scanning device configured to emit a signal to detect a detectable property of the valuable object if placed nearby the second scanning device, a second detection surface, the second detection surface located proximate the second scanning device, the second detection surface allowing a passage of the signal emitted by the second scanning device to detect the detectable property of the valuable object if placed nearby the second scanning device, and a notification system in communication with the first scanning device and the second scanning device, the notification system providing a real-time indication of a detection, by at least one of the first scanning device and the second scanning device, of a difference between an expected value of the detectable property of the valuable object and an actual value of the detectable property of the valuable object, wherein the first scanning device is located within a main housing unit and the second scanning device is located within a handheld portion.

A second aspect relates generally to a device for detecting counterfeit currency, the device comprising a main housing unit, the main housing unit including at least one scanning device configured to emit a signal to detect a detectable property of currency if placed nearby the at least one scanning device, a first opening located on a first surface of the main housing unit, the first opening configured to receive the currency, a second opening on a second surface of the main housing unit, the second opening configured to eject the currency, and a notification system located within the main unit housing, wherein when the currency enters the first opening and is mechanically advanced through the second opening, the at least one scanning device detects a detectable property of the currency to verify an authenticity of the currency, wherein the notification system provides a real-time indication of authenticity of the currency, the real-time identification of authenticity being at least one of a confirmation of authenticity if an actual property of the currency matches the expected property of the currency and a determination that the currency is counterfeit if a difference between the expected property of the currency and the actual property of the currency is detected.

A third aspect relates generally to a method of detecting counterfeit currency, the method comprising providing a detection device proximate a point of sale, the detection device including at least one scanning device, detecting a detectable property of one or more forms of currency when the currency is within a distance of the at least one scanning device, comparing the detected detectable property with a predetermined correct property of a genuine currency of the same denomination or form, and activating a real-time indicator if the detectable property of the currency does not match the predetermined correct property of the genuine currency of the same denomination or form of the currency being detected.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic, perspective view of a first embodiment of a detection device;

FIG. 2 depicts a schematic view of the first embodiment of the detection device;

FIG. 3 depicts a schematic view of the first embodiment of the detection device;

FIG. 4 depicts a schematic, perspective view of the second embodiment of a detection device; and

FIG. 5 depicts a schematic view of the second embodiment detection device.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

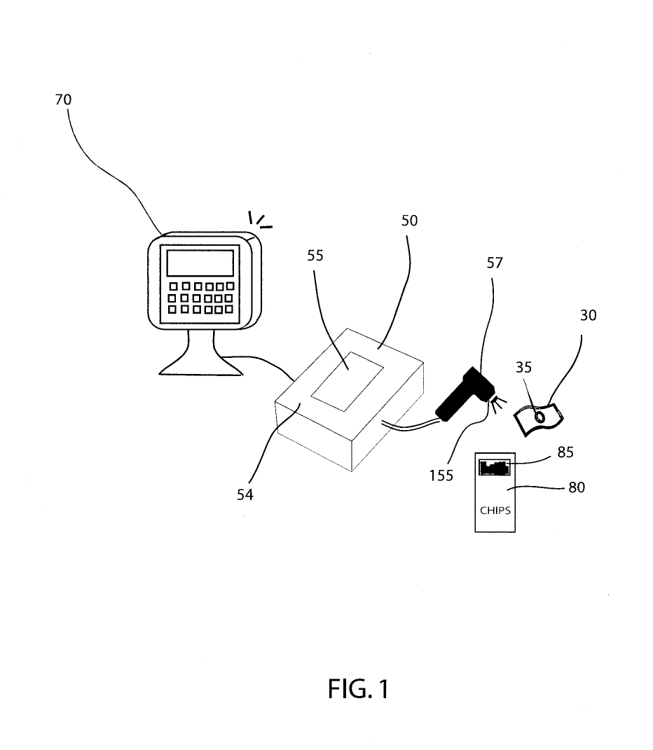

Referring to the drawings, FIG. 1 depicts an embodiment of a detection device 50. Embodiments of the detection device 50 may detect, determine, ascertain, etc., whether a form of currency 30 is genuine or counterfeit. Embodiments of the detection device 50 may be located directly at the point of sale to determine an authenticity of currency 30 at the moment the currency is being proffered by a retailer, a customer, client, purchaser, or any person exchanging currency 30. Embodiments of currency 30 may be money, coins, bills, such as U.S. Dollars, or any piece of paper that holds value and includes a detectable property 35. Embodiments of the detection device 50 may also detect an authenticity of a valuable object, wherein a valuable object may be any object, good, product, currency, ID card, that has a value, wherein value is measured by monetary standards or personal importance. Embodiments of detectable property 35 of currency 30 may be a trait, property, portion, inclusion, omission, symbol, design, EMR frequency, magnetic field, radio frequency, stain, unique identifier, material, weight, thickness, and the like, of the currency 30, marks only visible under certain light, and the like, that is either inherent, made with, attached, embedded, and/or identifiable with the currency 30. One example of a detectable property 35 of the currency 30 is magnetic ink used to print the currency 30. Another detectable property 35 of currency 30 is a level of conductivity that the currency 30 may have, wherein the resistance of the currency 30 may be detected. Another example of detectable currency 30 is fluorescent properties contained within the currency 30. Yet another example of a detectable property 35 of currency 30 is an optical property of the currency 30 that can be detected or sensed by a photocell or a camera and compared to valid patterns stored in memory; different patterns determine genuineness and denominations. Those having ordinary skill in the requisite art should appreciate that other detectable properties 35 of the currency 30 may be used in association with the scanning and detection being performed by the detection device 50.

Embodiments of a detection device 50 may be an individual unit, either operably coupled to or physically separate from a point of sale 70, such as a cash register, as shown in FIG. 1. Embodiments of the point of sale 70 may be a human. Embodiments of the point of sale 70 may be a cash register, a kiosk, an ATM machine (e.g. checking the authenticity of money being placed within an ATM machine), a self-checkout computing device and scanner, a scanner terminal, and the like. Further embodiments of the point of sale 70 may be any location or device where physical currency 30 is exchanged, dispensed, or collected, either human operated or assisted, or computer operated or assisted.

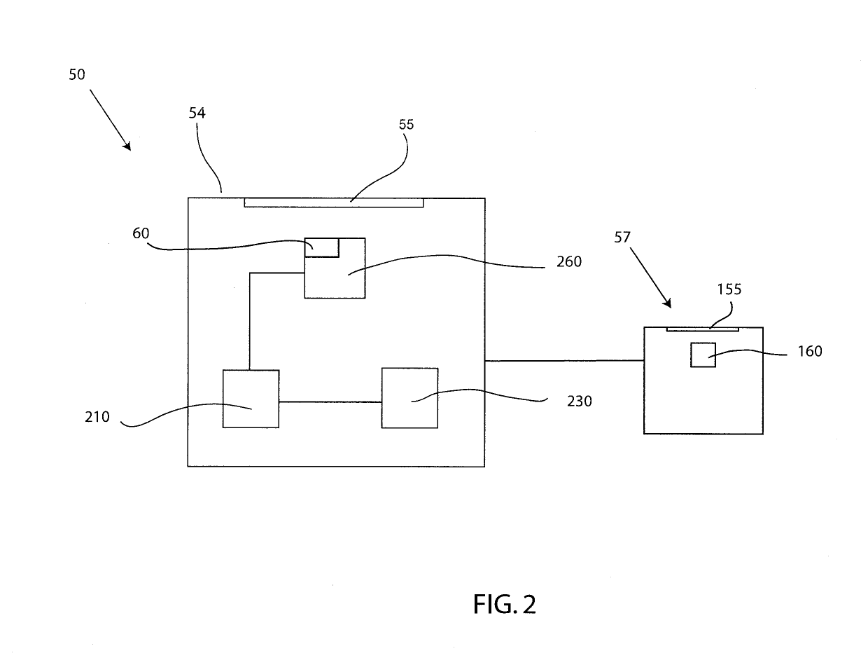

Referring still to FIG. 1, and with additional reference to FIG. 2, embodiments of the detection device 50 may include a scanning system 260, a computing system 210, and a notification system 230. Embodiments of the scanning system 260 and the notification system 230 may be coupled to the computing system, and may be located within a main housing unit 54 of the detection device 50. Embodiments of the main housing unit 54 may be an enclosure, a housing, a frame, a unit, and the like, configured to store, contain, protect, etc. the internals of the detection device 50, including embodiments of the computing system 210, the notification system 230, and the scanning system 260.

Embodiments of the scanning system 260 may include a first scanning device 60 and a second scanning device 160. Embodiments of the first scanning device 60 may be configured to emit a signal to detect a detectable property 35 of a valuable object, such as currency 30 if placed nearby the first scanning device 60. Embodiments of the first scanning device 60 may be a bar code reader, a bar code scanner, a scanner, a laser scanning device, an optical scanning device, a fluorescent scanning device, a magnetic scanning device, x-ray, bar code scanner, security code scanner, a UV wand or UV light, a checkout device, a mobile checkout device, a flatbed scanner, and the like, that may include a light source, a lens, a light sensor translating optical impulses into electrical ones, and decoder circuitry, wherein the embodiments of the first scanning device 60 can be located within the main housing unit 54. Embodiments of the detection device 50 may include more than one scanning device. For example, the first scanning device 60 of the detection device 50 may be able to scan goods 80 while also being able to scan currency 30. The first scanning device 60 may be in electrical communication with a powering device of the detection device 50, and may be located physically near the first detection surface 55 to improve detection of the currency 30 and/or good 80.

Embodiments of the second scanning device 160 may be configured to emit a signal to detect a detectable property 35 of the valuable object, or currency 30, if placed nearby the second scanning device 160. Embodiments of the second scanning device 160 may also be a bar code reader, a bar code scanner, a scanner, a laser scanning device, an optical scanning device, a fluorescent scanning device, a magnetic scanning device, x-ray, bar code scanner, security code scanner, a UV wand or UV light, a checkout device, a mobile checkout device, a flatbed scanner, and the like, that may include a light source, a lens, a light sensor translating optical impulses into electrical ones, and decoder circuitry. However, embodiments of the second scanning device 160 may be located within a handheld portion 57 of the detection device 50. Embodiments of the detection device 50 may include more than one scanning device. For example, the second scanning device 160 of the detection device 50 may be able to scan goods 80 while also being able to scan currency 30. The second scanning device 160 may be in electrical communication with a powering device of the detection device 50, and may be located physically near the second detection surface 155 to improve detection of the currency 30 and/or good 80.

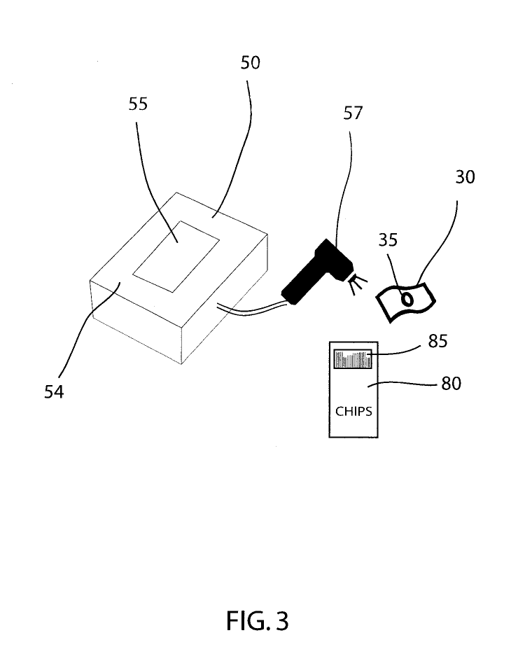

Furthermore, embodiments of the detection device 50 may have a first detection surface 55 somewhere along an exterior surface of a main housing unit 54 configured to be located proximate the first scanning device 60, the first detection surface 55 allowing a passage of the signal emitted by the first scanning device 60 to detect the detectable property 35 of the valuable object, or currency 30, if placed nearby the first scanning device 60. Embodiments of the first detection surface 55 may cooperate with the first scanning device 60 to detect/scan/authenticate one or more forms of currency 30 used to pay for the product or good 80. In other words, the first detection surface 55 may be exposed such that a bill or other form of currency 30 can be swiped across (touching or not touching) the first detection surface 55 to detect one or more detectable properties 35 in the currency 30. Embodiments of the detection surface 55 may be embedded, protruding from the outer surface, flush with the outer surface, or recessed from the outer surface of the detection device 50. The detection surface 55 (or second detection surface 155, as described infra) may be a clear or relatively transparent surface, such as glass, plexiglass, and the like, or may be a non-metallic surface, to allow the passage of EMR, such as a laser, magnetic field, or RF frequency, to improve detection of the detectable property 35. Embodiments of the first detection surface 55 may be a first detection surface 55, the first detection surface 55 may be located proximate the first scanning device 60, the first detection surface 55 allowing a passage of the signal emitted by the first scanning device 60 to detect the detectable property 35 of the valuable object 30 if placed nearby the first scanning device 60. In other embodiments, the detection device 50 may be integrated with the point of sale 70 such that the detection device 50, in particular, the detection surface 55, is configured to both scan/register a product or good 80 for sale, as shown in FIG. 3. In one embodiment, the detection device 50 may include elements associated with a point of sale, such as a money tray, while also having at least one detection surface 55 to check the authenticity of any currency 30 exchanged, collected, or dispensed.

Furthermore, embodiments of the detection device 50 may include a second detection surface 155. Embodiments of the second detection surface 155 may be located proximate the second scanning device 160, the second detection surface 155 allowing a passage of the signal emitted by the second scanning device 160 to detect the detectable property 35 of the valuable object, or currency 30, if placed nearby the second scanning device 160. Embodiments of the second detection surface 155 may share the same structural, functional, and/or electrical aspects of the first detection surface 50. However, embodiments of the second detection surface 155 may be embedded, located within, etc. a handheld portion 57 of the detection device 50.

Furthermore, embodiments of the detection device 50 may include a handheld portion 57. Embodiments of the handheld portion 57 may be connected to the main unit 54 through a wired connection or a wireless connection. For instance, embodiments of the handheld portion 57 may be in at least one of physical communication, signal communication, and cable communication with the main unit 54. Embodiments of the handheld portion 57 may house the second scanning device 160 so as to provide mobility in scanning a detectable property 35 of a valuable object; the second detection surface 155 may be positioned at various spatial locations, various angles, etc. For example, an operator may hold the handheld portion 57 in one hand and position the handheld portion 57 proximate the currency 30 and/or good 80 to detect a detectable property 35, 85 of the currency 30 and/or good 80, respectively. It will be appreciated that embodiments of the detection device 50 may include a first detection surface 155 embedded or contiguous with the main unit 54, while also having a handheld portion 57 detachably attached to the main unit 54, wherein the handheld portion 57 has its own detection surface 155 (second detection surface 155). The handheld portion 57 may include a grip section, a trigger section, and a barrel section, wherein the scanning device of the handheld portion 57 may be disposed within the barrel section.

Referring still to FIG. 2, embodiments of the detection device 50 may include a computing system 210, wherein the computing system may include a processor capable of executing one or more software applications, an input device coupled to the processor, an output device coupled to the processor, and memory devices each coupled to the processor.

Embodiments of the detection device 50 may also include a notification system 230. Embodiments of the notification system 230 may in communication with the computing system 210 and the scanning system 260. Accordingly, embodiments of the notification system may be in communication with the first scanning device 60 and the second scanning device 160. Embodiments of the notification system 230 may provide a real-time indication of a detection, by at least one of the first scanning device 60 and the second scanning device 160, of a difference between an expected value of the detectable property 35 of the valuable object and an actual value of the detectable property 35 of the valuable object.

With continued reference to FIGS. 1-3, embodiments of the detection device 50 may be configured to detect a detectable property 35 of currency 30 to determine an authenticity of the currency 30; authenticity of the currency 30 refers to whether or not the currency 30 is genuine or counterfeit. Embodiments of the detection device 50 may also scan a good or product 80 according to a detectable property 85 of the product or good 80. Scanning a product's 80 barcode or similar detectable property 85, by the detection device 50, to register the product 80 into a computer system at a point of sale 70, or an integrated detection device, may be similar to those systems/methods implemented at a local grocery store or department store when purchasing an item at the counter. Thus, an operator, or cashier, may first scan, using the detection device 50, a product or good 80 having a detectable property 85 to register the good 80 with the computing system 210 and notify a consumer of the cost of the good 80, and then detect/scan, using the detection device 50, an amount of currency 30 given to the operator by the consumer to ensure that one or more denominations/forms of the currency 30 are not counterfeit. Therefore, at a single point of sale 70, the detection device 50 may be used to scan both a good 80 to register the sale and ensure the authenticity of the currency 30 given in exchange for the good 80 to complete an honest, fair, and accurate transaction. However, an integrated detection device 50 allows an operator, such as a waiter, or other mobile salesman to both complete a purchase on-the-go but also ensure that the currency 30 he or she collects is not counterfeit; the integrated detection device 50 can be comprised of lightweight plastic for the main unit 54 and the handheld portion 57, which can allow an operator to wear or carry the integrated detection device 50 as he or she moves around. If the currency 30 being detected is not counterfeit, than an electronic signal is generated by the detection device 50, in particular the notification system 230 coupled to the computing system 210, to activate a real-time indicator to notify the operator and/or the consumer; embodiments of the detection device 50 may simply do nothing and not activate a real-time indicator if the currency 30 is genuine.

However, if the currency 30 given to an operator at a point of sale 70 and being detected is determined to be counterfeit, the detection device 50 may activate a real-time indicator, such as activating an alarm or light, sending an electronic communication, for example, through an e-mail, SMS, or MMS, or somehow notifying at least one of the operator, consumer, third party located a distance away from the device 50, 150 to the situation that a swiped, scanned, etc., piece of currency is likely or could be counterfeit. The detection device 50 may determine that the currency 30 is counterfeit when the scanning device in operable communication with the detection device 50 detects an error and/or difference between the reading/result/value of the detectable property 35 of the currency 30 being scanned, and the programmed, expected, acceptable reading/result/value of that particular type, form, or denomination of currency 30. Thus, by generating an error signal, the detection device 50 may indicate to the operator at the point of sale 70, or to the operator if utilizing an integrated detection device 50, that some or all of the currency 30 being scanned/detected is counterfeit. The error signal generated by the detection device 50 can be an electrical signal that indicates that the detectable property 35 of the currency 30 either was not present, did not match up with the properties stored in the detection software, yielded unexpected results based on that particular detectable property 35 associated with a given form/piece of currency 30, or other methods known to those having skill in the art.

Accordingly, the detection device 50 may alert the operator at the point of sale 70, or wherever the operator is located, through a real-time indication that the currency 30 is either counterfeit or genuine. One embodiment of a real-time indication is an alarm that makes an audible noise that both the operator and a consumer can hear. Another embodiment of the real-time indication of counterfeit currency 30 is a silent alarm, which alerts only the operator, and may be in communication with a law enforcement agency or an office located away from the store floor. Another embodiment of the real-time indication of counterfeit currency 30 may be a light or similar visible indicator to the operator or other store representative away from the store floor, or to both the consumer and the point of sale 70 operator. Yet another embodiment of a real-time indication may be a display or output device that is coupled to the computing system to display the result (e.g. green letters spelling “OK”, or red letters spelling “COUNTERFEIT”). Those having skill in the art should appreciate that may other real-time indications may be utilized, including an electronic communication to a law enforcement agency or on-site or off-site security personnel.

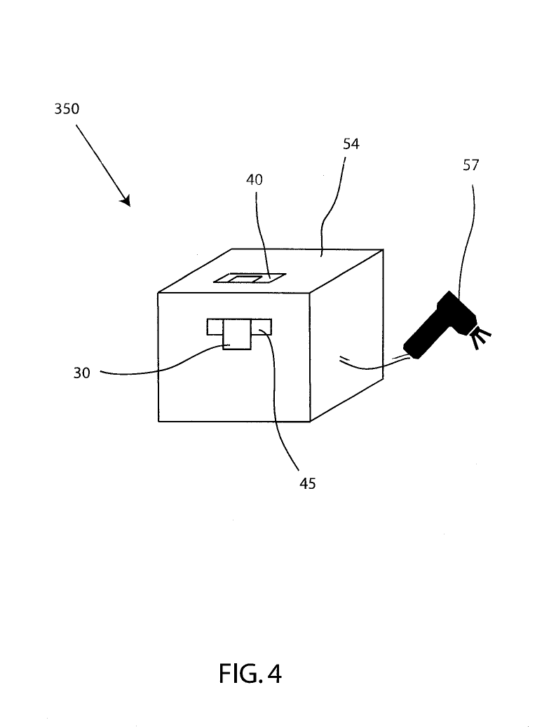

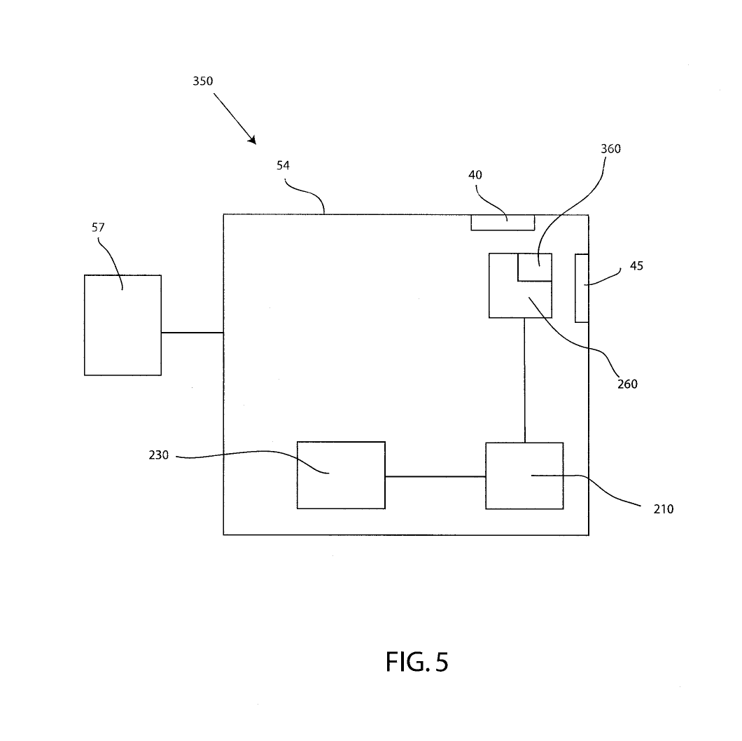

Referring now to FIGS. 4 and 5, embodiments of a detection device 350 may further include a first opening 40 and a second opening 45, wherein currency 30 may be inserted into the first opening 40 and exiting through the second opening 45, or vice versa. Embodiments of detection device 350 may share the same structural, functional and/or electrical aspects of the detection surface 50, described supra. Embodiments of the detection device 350 may include a main housing unit 54, the main housing unit 54 including at least one scanning device 360 configured to emit a signal to detect a detectable property 35 of the valuable object, or currency 30, if placed nearby the at least one scanning device 360, a first opening 40 located on a first surface of the main housing unit 54, the first opening 40 configured to receive currency 30, a second opening 45 on a second surface of the main housing unit 54, the second opening 45 configured to eject the currency 30, a notification system 230 located within the main unit housing 54, wherein when currency 30 enters the first opening 40 and mechanically advanced through the second opening 45, the at least one scanning device 360 detects a detectable property 35 of the currency 30 to verify an authenticity of the currency 30, wherein the notification system 230 provides a real-time indication of authenticity of the currency 30, the real-time identification of authenticity being at least one of a confirmation of authenticity if an actual property of the currency 30 matches the expected property of the currency and a determination that the currency is counterfeit if a difference between the expected property of the currency and the actual property of the currency is detected. Embodiments of the first opening 40 and the second opening 45 may be openings, slots, apertures, and the like, configured to accept and mechanically advance currency 30, such as any form or denomination of paper money.

Moreover, while the currency 30 enters the detection device 350 from the first opening 40 and passes through to and exits the second opening 45, a scanning device 360 may detect/scan the currency 30 as described above to ensure whether not the currency 30 is counterfeit. For instance, the scanning device 360 may be positioned somewhere between the first opening 40 and the second opening 45 within the detection device 350 in a position to effectively detect/scan/read the currency 30 passing in and out of the detection device 350. The result of the counterfeit check may be displayed on an output device, or similar display located on or proximate the detection device 350. Embodiments of detection devices 350 that include a first opening 40 and a second opening 45 may allow a bank or other institution to place a detection device 300 somewhere in the lobby for a customer to check and/or confirm the authenticity of a bill without dealing with a teller or cashier. Similarly, a detection device 350 having a first opening 40 and a second opening 45 configured to accept currency 30, and mechanically drive it through the detection device 350, may allow an operator such as a casino dealer to avoid touching the money 30 while determining if the money 30 is counterfeit, prior to depositing the money 30 into a safe box.

With continued reference to FIGS. 1-5, a method of detecting counterfeit currency may include the steps of providing a detection device 50, 350 proximate a point of sale or a cash register (unless the detection device 50, 350 is also the point of sale), wherein the detection device 50, 350 has a detection surface 55, 155 or a plurality of openings 40, 45, at least one of embedded within the detection device 50, 350 and within a handheld portion 57 of the detection device 50, 350, positioning a scanning device 60, 160, 360 proximate the detection surface 55, 155, or plurality of openings 40, 45, detecting a detectable property 35 of one or more forms of currency 30 when the currency is within a distance of the detection surface 55, 155 or scanning device 60, 160, 360. The steps of the method may further include the steps of comparing the detected detectable property 35 with a predetermined correct property of a genuine currency of the same denomination or form (e.g. issued by the U.S. government), and activating a real-time indicator if the detectable property 30 of the currency 30 does not match the predetermined correct property of the genuine currency of the same denomination or form of the currency being detected. Those skilled in the requisite art should appreciate that a match between the detectable property of the currency 30 being detected or scanned may either include or not include something. For instance, a genuine paper bill may include a unique marking on the upper right corner of the bill, only visible under UV light, which will not be present on the counterfeit currency when being detected by the detection device 50, 350.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A device for detecting counterfeit currency, the device comprising:
a first scanning device, the first scanning device configured to emit a signal to detect a detectable property of a valuable object if placed nearby the first scanning device;
a first detection surface, the first detection surface located proximate the first scanning device, the first detection surface allowing a passage of the signal emitted by the first scanning device to detect the detectable property of the valuable object if placed nearby the first scanning device;
a second scanning device, the second scanning device configured to emit a signal to detect a detectable property of the valuable object if placed nearby the second scanning device;
a second detection surface, the second detection surface located proximate the second scanning device, the second detection surface allowing a passage of the signal emitted by the second scanning device to detect the detectable property of the valuable object if placed nearby the second scanning device; and
a notification system in communication with the first scanning device and the second scanning device, the notification system providing a real-time indication of a detection, by at least one of the first scanning device and the second scanning device, of a difference between an expected value of the detectable property of the valuable object and an actual value of the detectable property of the valuable object;
wherein the first scanning device is located within a main housing unit and the second scanning device is located within a handheld portion.

2. The device of claim 1, wherein the notification system is located within the main housing unit and coupled to a computing system.

3. The device of claim 1, wherein the handheld portion is in at least one of physical communication, signal communication, and cable communication with the main housing unit.

4. The device of claim 1, wherein the detectable property of the valuable object is one or more of a trait, a property, a portion, an inclusion, an omission, a symbol, a design, an EMR frequency, a magnetic field, a radio frequency, a stain, a unique identifier, a material, a weight, a thickness, a plurality of marks only visible under certain light, wherein the detectable property of the valuable object is at least one of inherent, made with, attached, embedded, and identifiable with the valuable object.

5. The device of claim 1, wherein the valuable object is one or more forms of currency.

6. The device of claim 1, wherein the main housing unit is located at a point of sale.

7. The device of claim 1, wherein the signal of the first scanning device and the signal of the second scanning device is a laser beam, the laser beam configured to scan the detectable property of the valuable object.

8. The device of claim 1, wherein the first scanning device and the second scanning device also scans one or more products, wherein the one or more products are not a form of currency.

9. The device of claim 1, wherein the real-time indication is an electronic notification.

10. The device of claim 1, wherein the real-time indication is an alarm.

11. A device for detecting counterfeit currency, the device comprising:
a main housing unit, the main housing unit including at least one scanning device configured to emit a signal to detect a detectable property of currency if placed nearby the at least one scanning device;
a first opening located on a first surface of the main housing unit, the first opening configured to receive the currency;
a second opening on a second surface of the main housing unit, the second opening configured to eject the currency; and
a notification system located within the main unit housing;
wherein when the currency enters the first opening and is mechanically advanced through the second opening, the at least one scanning device detects a detectable property of the currency to verify an authenticity of the currency;
wherein the notification system provides a real-time indication of authenticity of the currency, the real-time identification of authenticity being at least one of a confirmation of authenticity if an actual property of the currency matches the expected property of the currency and a determination that the currency is counterfeit if a difference between the expected property of the currency and the actual property of the currency is detected.

12. The device of claim 11, wherein a handheld portion is connected to the main housing unit.

13. The device of claim 11, wherein the detectable property of the currency is one or more of a trait, a property, a portion, an inclusion, an omission, a symbol, a design, an EMR frequency, a magnetic field, a radio frequency, a stain, a unique identifier, a material, a weight, a thickness, a plurality of marks only visible under certain light, wherein the detectable property of the currency is at least one of inherent, made with, attached, embedded, and identifiable with the currency.

14. The device of claim 11, wherein the currency is a denomination of paper money.

15. The device of claim 11, wherein the main housing unit is located proximate at least one of a point of sale, a bank, and a casino.

16. The device of claim 11, wherein the signal of the at least one scanning device is a laser beam, the laser beam configured to scan the detectable property of the currency.

17. The device of claim 11, wherein the real-time indication is an electronic notification.

18. The device of claim 11, wherein the real-time indication is an alarm.

19. A method of detecting counterfeit currency, the method comprising:
providing a detection device proximate a point of sale, the detection device including at least one scanning device;
detecting a detectable property of one or more forms of currency when the currency is within a distance of the at least one scanning device;
comparing the detected detectable property with a predetermined correct property of a genuine currency of the same denomination or form; and
activating a real-time indicator if the detectable property of the currency does not match the predetermined correct property of the genuine currency of the same denomination or form of the currency being detected.

20. The method of claim 19, wherein the detectable property of the currency is one or more of a trait, a property, a portion, an inclusion, an omission, a symbol, a design, an EMR frequency, a magnetic field, a radio frequency, a stain, a unique identifier, a material, a weight, a thickness, a plurality of marks only visible under certain light, wherein the detectable property of the one or more forms of currency is at least one of inherent, made with, attached, embedded, and identifiable with the one or more forms of currency.
